(19) United States
(12) Patent Application Publication
(10) Pub. No.: US 2014/0143981 A1
(43) Pub. Date: May 29, 2014

(54) SELF-CLOSING DOOR HINGE

(71) Applicants: Nicolas Liermann, Rheda-Wiedenbrueck (DE); Ulrich Pelz, Ennigreloh (DE)

(72) Inventors: Nicolas Liermann, Rheda-Wiedenbrueck (DE); Ulrich Pelz, Ennigreloh (DE)

(21) Appl. No.: 14/090,642

(22) Filed: Nov. 26, 2013

(30) Foreign Application Priority Data
Nov. 28, 2012 (DE) 102012111519.2

(51) Int. Cl. E05F 1/12

(52) U.S. Cl. CPC E05F 1/12
USPC 16/277

(57) ABSTRACT

A door hinge that has a base attachable to a door frame and having a bushing centered on an axis and an anchor formation projecting radially outward from the bushing for attachment of the bushing to a door frame and a leaf having two hinge knuckles axially flanking the axis and an L-section web connecting the knuckles and itself having a flange attachable to an edge of a door panel. A spring-loaded closer urges the leaf into a closed position. The radial spacing between an outer surface of the bushing and the inner contact edge of the web is so small that a finger cannot engage therein, and, in the closed position with the inner contact edge engaging the anchor formation. The attachment flange is spaced from the anchor formation by a safety spacing so large that a finger cannot be pinched between the flange and the anchor formation.

### FIELD OF THE INVENTION

The present invention relates to a door hinge. More particularly this invention concerns a self-closing door hinge.

### BACKGROUND OF THE INVENTION

The invention relates to a door hinge, in particular for heavy-duty doors, interior doors, and front doors having a base attachable to a door frame and having a bushing centered on an axis and an anchor formation projecting radially outward from the bushing for attachment of the bushing to a door frame and a leaf having two hinge knuckles axially flanking the axis and an L-section web connecting the knuckles and itself having a flange attachable to an edge of a door panel. The leaf is pivotal about the axis relative to the base through a swing angle between a closed position and an open position and having an inner contact edge at a predetermined radial spacing from the bushing. A spring-loaded closer engaged between the leaf and the base is loadable by pivoting of the leaf from the closed position through a load angle forming part of a larger swing angle. The closer only exerts a return force on the leaf toward the closed position within the load angle and the leaf is freely pivotal relative to the base in a free-movement part of the swing angle between the load angle and the open position without the closer exerting a return force on the leaf.

The term “heavy-duty door” comprises among other things entrance doors, break-in-resistant doors, noise-protection doors, smoke-protection doors, and fire-protection doors. The door hinge is equipped with a mechanical self-closing mechanism that assists closing with a tension spring. The effect of the self-closing mechanism is limited an opening angle of the door panel, that, is smaller than the swing angle executed by the door panel when opening.

The basic construction of the door hinge includes a leaf attachable to an edge of a door panel and having two axially aligned hinge knuckles connected by a web, a base attachable to a door frame and having a bushing rotatable between the hinge knuckles as well as an anchor formation attachable to the door frame, connected to the bushing, and projecting outward, and a closer with a tension spring that can be tensioned by pivoting of the door panel from a closed position into a free-movement range and that stays tensioned when in the free-movement range. In the free-movement range, the leaf is rotatable without a return force relative to the base and executes in an angle range between the closed position and the free-movement range a self-actuated swing motion into the closed position when subjected to the return force of the tension spring. The web of the leaf is constructed as an angled profile and has a flange extending in the closed position of the leaf in the same direction as the connecting element of the base. A door hinge with the described features is known from DE 10 2009 033 222.

From the combination of free movement and a closing mechanism, there results a risk of injury in handling the door hinge. For example if the door hinge is taken out of the packaging, or if a door panel with the door hinge attached to it is installed or removed, the effect of the closer may be unintentionally activated. With a snapping motion, the leaf and the base strike each other, generating large clamping and crushing forces between the flange of the leaf and the anchor formation of the base. Since the leaf and the base in the free-movement range extend over a large angular range and are freely rotatable relative to each other without any return forces, the user does not expect the effect of the closer when handling the door hinge, and the user cannot also not foresee at what angular position the closer will act to snap the door hinge shut. For the self-closing mechanism of a heavy door panel, large spring forces are necessary and due to the large spring force for which the tension spring must be configured, there results a substantial risk of injury to limb extremities if a closing motion occurs uncontrollably due to the above-given reasons and the leaf as well as the base strike each other when handling or installing the door hinge.

### OBJECTS OF THE INVENTION

It is therefore an object of the present invention to provide an improved self-closing door hinge.

Another object is the provision of such an improved self-closing door hinge that overcomes the above-given disadvantages, in particular that eliminates the danger of finger-pinching and -crushing.

### SUMMARY OF THE INVENTION

The instant invention is an improvement in a door hinge that has a base attachable to a door frame and having a bushing centered on an axis and an anchor formation projecting radially outward from the bushing for attachment of the bushing to a door frame and a leaf having two hinge knuckles axially flanking the axis and an L-section web connecting the knuckles and itself having a flange attachable to an edge of a door panel. The leaf is pivotal about the axis relative to the base through a swing angle between a closed position and an open position and has an inner contact edge at a predetermined radial spacing from the bushing. A spring-loaded closer as in above-cited DE 10 2009 033 222, which is herewith incorporated by reference, is engaged between the leaf and the base and loadable by pivoting of the leaf from the closed position through a load angle forming part of a larger swing angle. The closer only exerts a return force on the leaf toward the closed position within the load angle such that the leaf freely pivotal relative to the base in a free-movement part of the swing angle between the load angle and the open position without the closer exerting a return force on the leaf.

According to the invention this system is made safer in that the fixed radial spacing between an outer surface of the bushing and the inner contact edge of the web is so small that a finger cannot engage therein, and, in the closed position of the door with the inner contact edge engaging the anchor formation, the attachment flange is spaced from the anchor formation by a safety spacing so large that a finger cannot be pinched between the flange and the anchor formation.

In other words, according to the invention, the web has a contact edge limiting the closing motion of the leaf and forming with the outer surface of the bushing of the base a small gap such that finger penetration into the gap is not possible and that at the narrowest place between the anchor formation of the base supported on the contact edge and the flange of the leaf, there remains a safety clearance that is sufficiently large such that fingers cannot be crushed between the flange and the anchor formation. Hence, a risk of injury in handling the door hinge is thus completely excluded because there is not a gap between the cylindrical outer surface of the bushing and the contact edge of the leaf into which a finger may be accidentally inserted, and that in the closed position, sufficient room remains between the flange of the leaf and the anchor formation of the base that limb extremities cannot be injured if the self-closing action of the closer is activated and the leaf and the base strike each other. The teaching according to the invention allows for a snapping-together motion of the movable parts of the door hinge, but ensures that the snapping motion does not result in any risk of injury.

The web of the leaf is spaced from the rotatable bushing of the base by a gap of less than 4 mm in an essentially tangential manner. The gap is preferably no more than 2 mm.

Within the scope of the invention, a basic aspect is the bushing formed with a projection that contacts the contact edge of the leaf and establishes the orientation of the leaf and the anchor formation in the closed position of the door hinge. According to a preferred embodiment of the invention, in the closed position, the anchor formation of the base lies directly against the contact edge of the leaf. The contact edge is narrow. Its width corresponds to the thickness of the sheet metal from which the leaf is produced. Due to the narrow width and the spatial proximity to the outer surface of the bushing of the base, no crushing hazard results from the contact edge. The contact edge and the anchor formation of the base are appropriately arranged relative to each other so that the enclosed angle between the leaf web engaging the hinge knuckle and the anchor formation of the base supported on the contact edge is greater than 70°.

The safety clearance between the flange and the anchor formation must be at least 4 mm in the closed position. A safety clearance of 8 mm or more is preferred.

The anchor formation of the base is designed in an essentially known manner. It may consist in particular of an arrangement with two pins or one flat hinge tab. Such a hinge tab may be designed for engagement complementary tab-shaped seat.

According to a preferred embodiment of the invention, the closer is integrated in a multipart pivot pin connecting the leaf to the base. The pivot pin may have a construction known from above-cited DE 10 2009 033 222.

### BRIEF DESCRIPTION OF THE DRAWING

The above and other objects, features, and advantages will become more readily apparent from the following description, reference being made to the accompanying drawing in which:

FIG. 1 is a perspective view of a door hinge according to the invention; and

FIG. 2 is an end view of the hinge of FIG. 1 in a closed position.

### SPECIFIC DESCRIPTION OF THE INVENTION

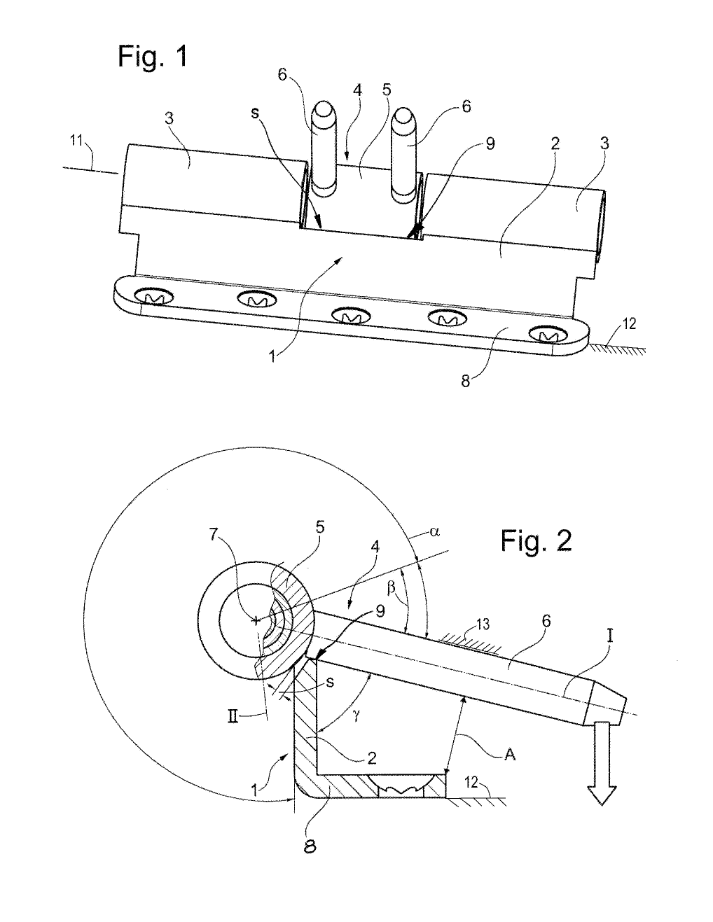

As seen in FIGS. 1 and 2 a door hinge in accordance with the invention has a leaf 1 attachable to an edge of a door panel shown schematically at 13 and comprised of two aligned hinge knuckles 3 aligned along an axis 10 and connected by a web 2. The other part of the hinge is formed by a base 4 attachable to a door frame shown schematically at 12. The base 4 has a bushing 5 rotatable about an axis 11 between the hinge knuckles 3 as well as an anchor formation 6 connected to the bushing 5 and projecting outward for attachment to a door frame. The anchor formation 6 may, depending on the embodiment, consist of two pins or alternatively also of a hinge tab fittable into a complementary seat.

The leaf 1 and the base 4 are connected by a pivot pin 7 that, in a multipart design, is provided with a closer. This closer has a spring that can be tensioned by pivoting of the leaf 1 from a closed position I to a free-movement range II and stays tensioned in the free-movement range II. The design of such a pivot pin with an integrated closer is known for example from DE 10 2009 033 222.

The leaf 1 can be rotated relative to the base 4 about the axis 11 through a swing angle α+β of more than 180°. The pivoting starts at a closed position I and ends at an open position II. In a small part β of the total swing angle the closer is effective. In the free-movement range α, the leaf 1 is rotatable without hindrance relative to the base 4. In the angle β between the closed position I and the free-movement range II, the leaf 1 executes, under the return force of the tension spring, a self-actuated pivot motion toward the closed position I.

From a comparison of FIGS. 1 and 2, one can see that the web 2 of the leaf 1 is an angle of L-section and has a flange 8 extending radially in the closed position I of the leaf 1 generally in the same direction as the anchor formation 6 of the base 4. The web 2 of the leaf 1 has an inner contact edge 9 limiting its closing motion by engaging the outer surface of the bushing 5 of the base 4 with a small gap s in such a manner that finger penetration into the gap s is not possible, and that at the narrowest place between the anchor formation 6 of the base 4 supported on contact edge 9 and the flange 8 of the leaf 1, a is safety clearance A remains that is sufficiently large such that fingers cannot be crushed between the flange 8 and the anchor formation 6.

The web 2 of the leaf 1 is spaced from the rotatable bushing 5 of the base 4 in an essentially tangential manner with a gap s of less than 4 mm. Preferably, the gap does not exceed 2 mm.

From FIG. 2, one can see that the anchor formation 6 of the base 4 in the closed position engages the contact edge 9 of the leaf 1. The enclosed angle between the web 2, engaging hinge knuckles 3, of the leaf 1 and the anchor formation 6 of the base 4 supported on the contact edge 9 is greater than 70°. The enclosed angle γ as well as the dimensions of the angle-iron web 2 section are selected in such a manner that a safety clearance A between the flange 8 and the anchor formation 6 in the closed position is at least 4 mm. A safety clearance A of more than 8 mm is preferred.

We claim:

1. In a door hinge comprising:
a base attachable to a door frame and having a bushing centered on an axis and an anchor formation projecting radially outward from the bushing for attachment of the bushing to a door frame;
a leaf having two hinge knuckles axially flanking the axis and an L-section web connecting the knuckles and itself having a flange attachable to an edge of a door panel, the leaf being pivotal about the axis relative to the base through a swing angle between a closed position and an open position and having an inner contact edge at a predetermined radial spacing from the bushing; and
a spring-loaded closer engaged between the leaf and the base and loadable by pivoting of the leaf from the closed position through a load angle forming part of a larger swing angle, the leaf closer exerting a return force on the leaf toward the closed position within the load angle such that the leaf is freely pivotal relative to the base in a free-movement part of the swing angle between the load angle and the open position without the closer exerting a return force on the leaf,
the improvement wherein
the fixed radial spacing between an outer surface of the bushing and the inner contact edge of the web is so small that a finger cannot engage therein, and
in the closed position of the door with the inner contact edge engaging the anchor formation the attachment flange is spaced from the anchor formation by a safety clearance so large that a finger cannot be pinched between the flange and the anchor formation.

2. The door hinge defined in claim 1, wherein the fixed radial spacing between the inner contact edge and the outer surface of the bushing is less than 4 mm.

3. The door hinge defined in claim 1, wherein the fixed radial spacing between the inner contact edge and the outer surface of the bushing is less than 2 mm.

4. The door hinge defined in claim 1, wherein in the closed position the inner contact edge engages the anchor formation.

5. The door hinge defined in claim 1, wherein in the closed position the web forms with the anchor formation is at least 70°.

6. The door hinge defined in claim 1, wherein the safety clearance is at least 4 mm.

7. The door hinge defined in claim 1, wherein the safety clearance is at least 8 mm.

8. The door hinge defined in claim 1, wherein the anchor formation is two radially extending and generally parallel pins.

9. The door hinge defined in claim 1, further comprising:
a multipart pivot pin rotationally connecting the knuckles to the bushing.
